(19) United States
(12) Patent Application Publication
(10) Pub. No.: US 2025/0392517 A1
(43) Pub. Date: Dec. 25, 2025

(54) MULTI-INSTANCE SINGLE LOOP TOPOLOGY ADJUSTMENT METHOD AND NETWORK SWITCH

(71) Applicant: REALTEK SEMICONDUCTOR CORP., HsinChu (TW)

(72) Inventors: Chien-Hung Cheng, HsinChu (TW); Chih-Ming Chiu, HsinChu (TW); Kai-Wen Cheng, HsinChu (TW)

(73) Assignee: REALTEK SEMICONDUCTOR CORP., HsinChu (TW)

(21) Appl. No.: 18/964,831

(22) Filed: Dec. 2, 2024

(30) Foreign Application Priority Data
Jun. 20, 2024 (TW) 113122997

(51) Int. Cl. H04L 41/12; H04L 41/0654

(52) U.S. Cl. CPC H04L 41/12; H04L 41/0654

(57) ABSTRACT

A multi-instance single loop topology adjustment method and network switch are provided. The single loop networks of each instance have distinct back-up ports, defaulted to a blocking state. Thus, when abnormalities occur in a link of the single loop network, the topology of each instance is adjusted by changing the back-up ports of each instance to a forwarding state.

### CROSS-REFERENCE TO RELATED APPLICATION

This non-provisional application claims priority under 35 U.S.C. § 119(a) to patent application No. 113122997 filed in Taiwan, R.O.C. on Jun. 20, 2024, the entire contents of which are hereby incorporated by reference.

### BACKGROUND

### Technical Field

The instant disclosure relates to network topology technology, and in particular to a multi-instance single loop topology adjustment method and network switch.

### Related Art

In network technology, Spanning Tree Protocol (STP) technology is an important technology for switches, which is used to avoid various problems caused by the network loop. However, it takes 30 seconds to complete construction for the traditional STP technology, and data can be transmitted only after the construction is completed. When the network topology changes, it takes 30 seconds for the STP technology to return to a stable state, which has a long time for construction. Therefore, predecessors improve the STP technology and proposed Rapid Spanning Tree Protocol (RSTP) technology. However, it still takes 2 to 3 seconds for the RSTP technology to complete/reconstruct the network topology. For the size of data transmitted over the network today, the RSTP technology still causes a huge loss of information.

### SUMMARY

The instant disclosure provides a multi-instance single loop topology adjustment method, applied to a single loop network. The single loop network includes a plurality of network switches connected in series in a loop. Each of the network switches includes two control ports, and every adjacent two of the network switches are respectively connected via the corresponding control ports. One of the network switches is a back-up switch, and the rest network switches are each a normal switch. The multi-instance single loop topology adjustment method includes: defaulting, in a first network instance, a first port in the two control ports of the back-up switch to a blocking state; defaulting, in a second network instance, a second port in the two control ports of the back-up switch to the blocking state; sending, in response to abnormalities occurring in a link of the single loop network, a recovery control frame by the network switch connected to the link such that the recovery control frame is transmitted to the back-up switch via the single loop network; and setting, in response to receiving the recovery control frame, the first port in the blocking state in the first network instance to a forwarding state by the back-up switch, and setting the second port in the blocking state in the second network instance to the forwarding state.

The instant disclosure further provides a network switch, including two control ports and a processing circuit. The processing circuit is coupled to the two control ports and executes the following steps: first, determining whether either of the two control ports in a network instance is defaulted to a blocking state, if so, determining that the processing circuit is a back-up switch in the network instance, and if not, determining that the processing circuit is a normal switch in the network instance; if determining that the processing circuit is the normal switch in the network instance, executing the following determination logic, including: determining whether abnormalities occurring in a link connected to either of the control ports are detected, if so, setting the control port connected to the abnormal link to the blocking state, and sending a recovery control frame via the other control port according to the network instance; if determining that the processing circuit is the back-up switch in the network instance, executing the following determination logic, including: determining whether the recovery control frame is received in the network instance, and if so, setting the control port in the blocking state in the network instance to a forwarding state; and sending the recovery control frame to a controller via a redirect port.

According to the multi-instance single loop topology adjustment method and network switch provided in some embodiments of the instant disclosure, different back-up ports are configured for different network instances, so that virtual local area network traffic is transmitted along different paths in the network instances, and thus, the traffic can be dispersed. Moreover, for the abnormalities occurring in the link, the network instances each send control frames to adjust and recover the topology. In addition, in some embodiments, the block control frame and the recovery control frame are forwarded to the controller via the redirect port, so that the data path can be further dynamically adjusted according to the link condition.

### BRIEF DESCRIPTION OF THE DRAWINGS

FIG. 1 is a block diagram of an embodiment of a network switch according to the instant disclosure;

FIG. 2 is a block diagram of an embodiment of a single loop network according to the instant disclosure;

FIG. 3A is a schematic diagram of the single loop network in an initial state in a first network instance according to an embodiment of the instant disclosure;

FIG. 3B is a schematic diagram of the single loop network in an initial state in a second network instance according to an embodiment of the instant disclosure;

FIG. 4 is a flowchart (I) of a multi-instance single loop topology adjustment method according to an embodiment of the instant disclosure;

FIG. 5A is a schematic diagram showing abnormalities occurring in the single loop network in the first network instance according to an embodiment of the instant disclosure;

FIG. 5B is a schematic diagram showing abnormalities occurring in the single loop network in the second network instance according to an embodiment of the instant disclosure;

FIG. 6A is a schematic diagram of an alternate topology of the single loop network in the first network instance according to an embodiment of the instant disclosure;

FIG. 6B is a schematic diagram of an alternate topology of the single loop network in the second network instance according to an embodiment of the instant disclosure;

FIG. 7 is a flowchart (II) of a multi-instance single loop topology adjustment method according to an embodiment of the instant disclosure;

FIG. 8A is a schematic diagram showing recovery of a link in the single loop network in the first network instance according to an embodiment of the instant disclosure;

FIG. 8B is a schematic diagram showing recovery of a link in the single loop network in the second network instance according to an embodiment of the instant disclosure;

FIG. 9A is a schematic diagram showing recovery of a topology in the single loop network in the first network instance according to an embodiment of the instant disclosure;

FIG. 9B is a schematic diagram showing recovery of a topology in the single loop network in the second network instance according to an embodiment of the instant disclosure;

FIG. 10 is a flowchart of a network switch initialization procedure according to some embodiments of the instant disclosure;

FIG. 11 is a flowchart of an execution procedure of a processing circuit of a normal switch according to some embodiments of the instant disclosure; and

FIG. 12 is a flowchart of an execution procedure of a processing circuit of a back-up switch according to some embodiments of the instant disclosure.

### DETAILED DESCRIPTION

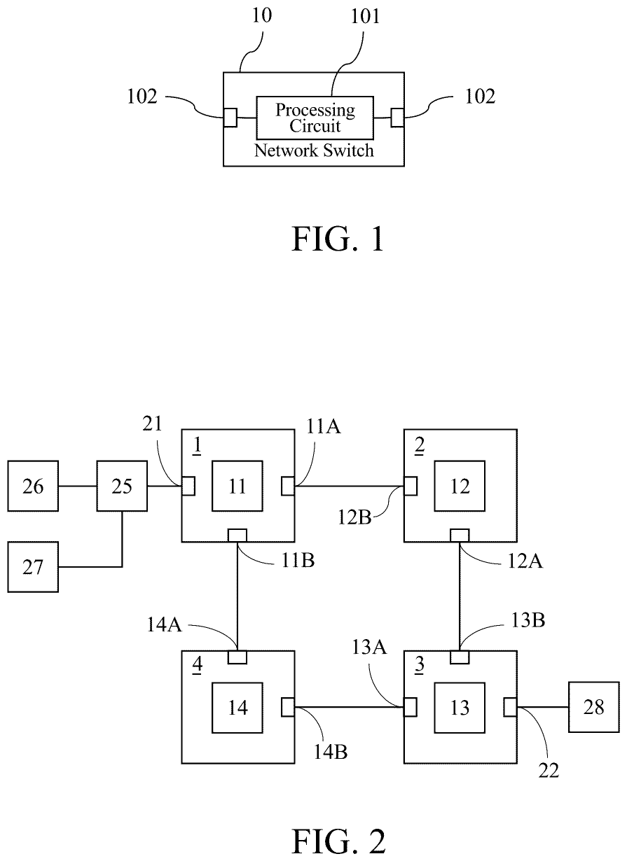

FIG. 1 is a block diagram of an embodiment of a network switch 10 according to the instant disclosure. Referring to FIG. 1, the network switch 10 includes a processing circuit 101 and a plurality of control ports 102. FIG. 1 is an example of a network switch 10 including two control ports 102, but the instant disclosure is not limited thereto, and the network switch 10 may further include other ports.

The control port 102 may be defaulted to a forwarding state or a blocking state. The processing circuit 101 is coupled to the control ports 102, and may set the control ports 102 to the forwarding state or the blocking state. When the network switch 10 is in a path of a single loop network, if the control port 102 is in the forwarding state, the control port 102 may receive a data frame transmitted by a previous network switch 10 in the single loop network, and may forward data frames received by the other control ports 102 to a next network switch 10 in the single loop network. In other words, the control port 102 in the forwarding state may receive and forward data frames. If the control port 102 is in the blocking state, the control port 102 may receive the data frame transmitted by the previous network switch 10, but does not forward the data frame to the next network switch 10 via the other control ports 102. In other words, the control port 102 in the blocking state may receive data frames, and does not forward data frames.

Based on this, since the processing circuit 101 sets the control ports 102 to the forwarding state or the blocking state, the control ports 102 of the network switch 10 may be connected to ports of other same network switches 10 through transmission lines, and the other network switches 10 may also set their control ports 102 to the forwarding state or the blocking state so as to form a single loop network between the network switch 10 and the other network switches 10, thereby avoiding the network topology loop.

Here, the network switch 10 with the control port 102 defaulted to the blocking state is referred to as a back-up switch, and the network switch 10 without the control port 102 defaulted to the blocking state (that is, all the control ports 102 are defaulted to the forwarding state) is referred to as a normal switch. The control port 102 defaulted to the blocking state may also be referred to as a back-up port.

FIG. 2 is a block diagram of an embodiment of a single loop network according to the instant disclosure. This embodiment has four aforementioned network switches 10 (i.e., network switches 1 to 4), and the network switches 1 to 4 are connected in series in a loop to form the single loop network. Every adjacent two of the network switches 1 to 4 are respectively connected via the corresponding control ports 11A to 14A and 11B to 14B. The processing circuits 11 to 14 of the network switches 1 to 4 set the corresponding control ports 11A to 14A and 11B to 14B defaulted to the forwarding state or the blocking state. This single loop network is applied to a plurality of network instances. In each network instance, one of all the control ports 11A to 14A and 11B to 14B in the single loop network is defaulted to the blocking state (i.e., set as the back-up port), and the control ports 102 defaulted to the blocking state are different from each other in different network instances. Each network instance may support one or more virtual local area networks (VLANs). Since the control ports 102 defaulted to the blocking state are different from each other in the network instances, virtual local area network traffic is transmitted along different paths in the network instances, and thus, the traffic can be dispersed.

As shown in FIG. 2, in some embodiments, the network switch 1 has another port (hereinafter referred to as a redirect port 21), which is connected to a controller 26 and a network apparatus 27 via a hub 25. The network switch 3 has another port 22, which is connected to a network apparatus 28. The network apparatus 27 and the network apparatus 28 may communicate with each other via the single loop network. The network apparatuses and the controller 26 may be terminal apparatuses such as computers, mobile phones, tablet computers, servers, etc. In some embodiments, the network switch 1 may have other ports (not shown in the figure) so as to be connected to the network apparatus 27. The instant disclosure does not limit the need to be connected to the network apparatus 27 via the redirect port 21.

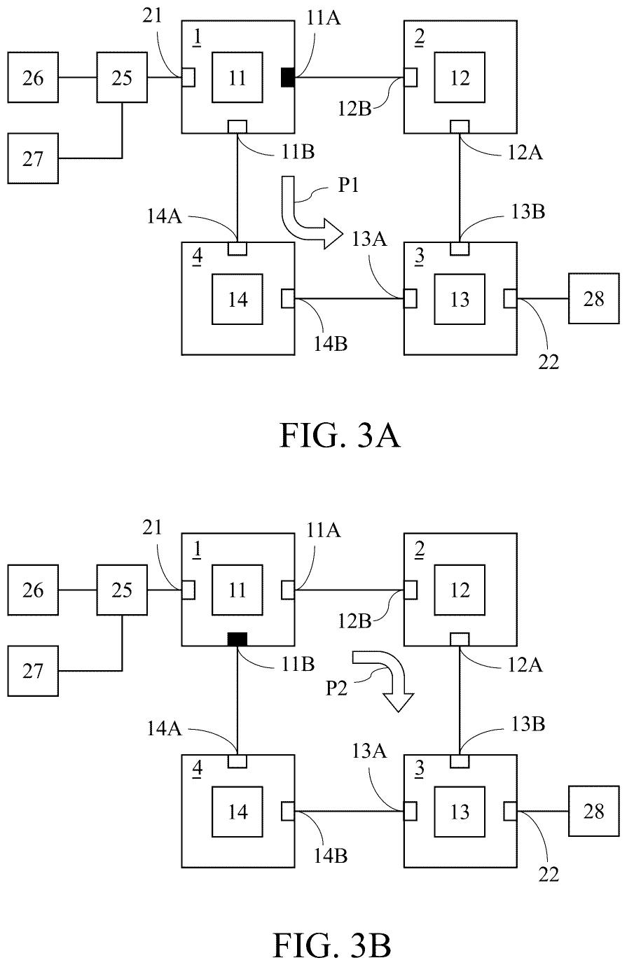

FIG. 3A and FIG. 3B are respectively schematic diagrams of the single loop network in an initial state in a first network instance and a second network instance according to an embodiment of the instant disclosure. For example, in the first network instance, the control port 11A of the network switch 1 is defaulted to the blocking state, and the rest control ports 12A to 14A and 11B to 14B are defaulted to the forwarding state (as shown in FIG. 3A). In the second network instance, the control port 11B of the network switch 1 is defaulted to the blocking state, and the rest control ports 11A to 14A and 12B to 14B are defaulted to the forwarding state (as shown in FIG. 3B).

Here, filled color blocks represent the control ports 102 in the blocking state, and hollow color blocks represent the control ports 102 in the forwarding state. After the single loop network is created, the network switches 1 to 4 may transmit data frames to each other, and any of the network switches 1 to 4 does not repeatedly transmit the data frame sent by itself. For example, in an example of FIG. 3B where the network switch 1 transmits a data frame via the control port 11A, the data frame, after sequentially passing through the network switches 2, 3 and 4, is transmitted back to the control port 11B of the network switch 1 in the blocking state by the network switch 4, and the data frame will not be forwarded out.

In addition to forwarding the data frame, the network switch 10 whose control ports 102 are all in the forwarding state may also forward the control frame. That is, when one control port 102 of the network switch 10 receives a control frame, the control frame is forwarded by another control port 102. The control frame may include a forward control frame FF, a recovery control frame RF and a block control frame BF. The control frames are used for enabling the single loop network to readjust and recover the network topology, which will be described later. Although the control port 102 in the blocking state does not forward the control frame (i.e., does not transmit the control frame received by another control port 102 via the control port 102 in the blocking state), the control port 102 in the blocking state may still receive the control frame and actively send the control frame.

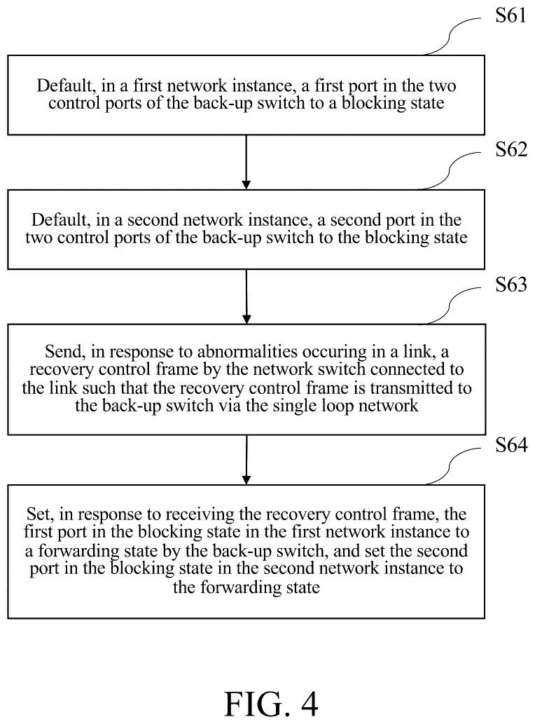

FIG. 4 is a flowchart (I) of a multi-instance single loop topology adjustment method according to an embodiment of the instant disclosure.

Step S61: As shown in FIG. 3A, in a first network instance, a first port (the control port 11A here) in the two control ports 102 of the back-up switch (the network switch 1 here) is defaulted to a blocking state.

Step S62: As shown in FIG. 3B, in a second network instance, a second port (the control port 11B here) in the two control ports 102 of the back-up switch (the network switch 1 here) is defaulted to the blocking state. As can be seen, in the two network instances, there are different control ports 102 respectively being set to the blocking state. Therefore, when a data frame sent by the network apparatus 27 is transmitted to the network apparatus 28 via the single loop network, the data frame will be transmitted along a first path P1 (as shown in FIG. 3A) if it is in the first network instance, and the data frame will be transmitted along a second path P2 (as shown in FIG. 3B) if it is in the second network instance. That is, the frame transmitted to a destination apparatus (the network apparatus 28 as described above) via the single loop network is respectively transmitted along different paths (the first path P1 and the second path P2) in the first network instance and the second network instance.

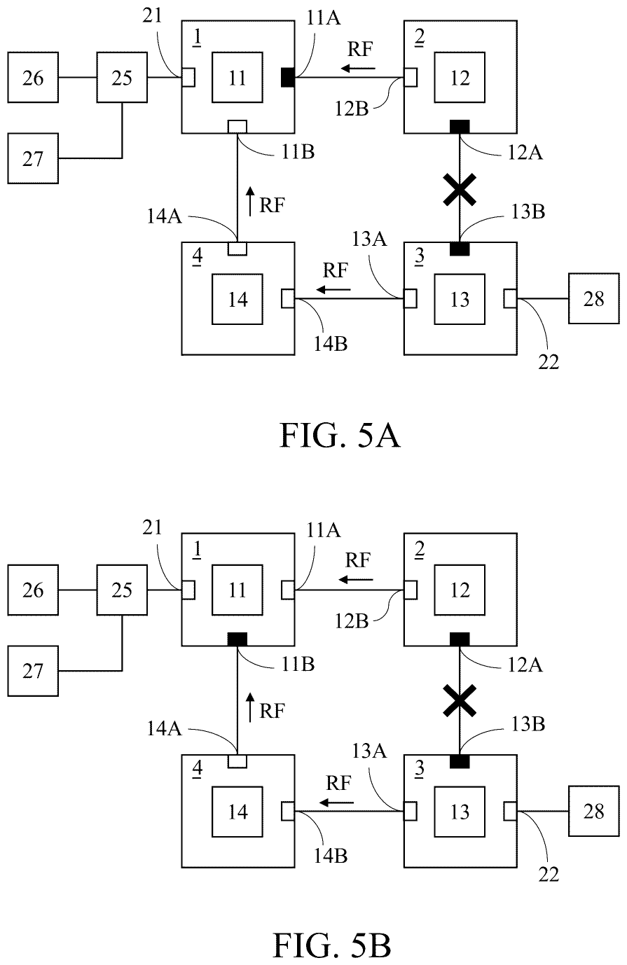

Step S63: In response to abnormalities occurring in a link of the single loop network, the network switch 10 connected to the link sends a recovery control frame RF such that the recovery control frame RF is transmitted to the back-up switch via the single loop network. FIG. 5A and FIG. 5B are respectively schematic diagrams showing abnormalities occurring in the single loop network in the first network instance and the second network instance according to an embodiment of the instant disclosure. Here, the description is made in an example where abnormalities occur in the link between the network switch 2 and the network switch 3. The network switch 2 detects abnormalities occurring in the link via the control port 12A, and sends the recovery control frame RF via the other control port 12B. Similarly, the network switch 3 detects abnormalities occurring in the link via the control port 13B, and sends the recovery control frame RF via the other control port 13A. Here, the control port 102 connected to the abnormal link is also referred to as an abnormal port, and the network switch 10 that detects abnormalities occurring in the link is also referred to as an abnormal switch. The recovery control frame RF is forwarded via other network switches 10 and finally transmitted to the network switch 1 (the back-up switch). It should be particularly noted that the recovery control frame RF is sent in both the first network instance and the second network instance.

The abnormalities occurring in the link may be, for example, abnormalities in the physical layer such as damage to the control port 12A or the control port 13B, damage to the transmission line between the control port 12A and the control port 13B, or disconnection of the transmission line from the control port 12A or the control port 13B. However, the instant disclosure is not limited thereto. The abnormalities may also be traffic congestion abnormalities. In this case, the abnormal link in the two network instances may occur at different positions, or abnormalities occur in one network instance and there are no abnormalities in the other network instance.

In some embodiments, the abnormalities of the link may occur in a certain network switch 10, for example, a fault occurs in the network switch 3. In this case, the control port 12A of the network switch 1 connected to the network switch 2 and the control port 14B of the network switch 4 are abnormal ports, and the network switches 2 and 4 that detect abnormalities in the link are referred to as abnormal switches. In order to avoid being tediously long, subsequent processing will be described in an example where the abnormalities occur in the link between the network switch 2 and the network switch 3, and those skilled in the art should be able to apply it to the case where abnormalities occur to a certain network switch 10 by analogy, which will not be described in detail.

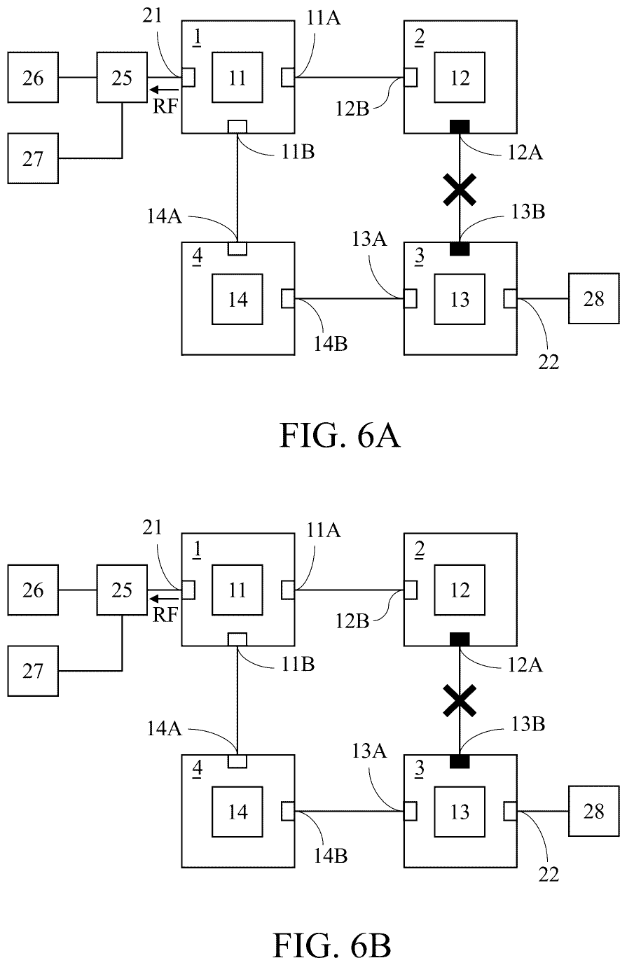

Step S64: As shown in FIG. 6A and FIG. 6B, in response to receiving the recovery control frame RF, the back-up switch (the network switch 1 here) sets the first port (the control port 11A) in the blocking state in the first network instance to a forwarding state, and sets the second port (the control port 11B) in the blocking state in the second network instance to the forwarding state. FIG. 6A and FIG. 6B are respectively schematic diagrams of an alternate topology of the single loop network in the first network instance and the second network instance according to an embodiment of the instant disclosure. Here, the control ports 11A and 11B originally in the blocking state are used as back-up ports. By switching the back-up ports to the forwarding state, the single loop network can be readjusted so as to resume to normal operation.

In some embodiments, the back-up switch (the network switch 1 here) has a redirect port 21, and the back-up switch transmits the recovery control frame RF to the controller 26 via the redirect port 21 in response to receiving the recovery control frame RF. The recovery control frame RF carries an abnormal switch information and an abnormal port information when it is generated. Specifically, the recovery control frame RF sent by the network switch 2 includes: an abnormal switch information corresponding to the network switch 2 and an abnormal port information corresponding to the control port 12A. Similarly, the recovery control frame RF sent by the network switch 3 includes: an abnormal switch information corresponding to the network switch 3 and an abnormal port information corresponding to the control port 13B. In this way, the controller 26 can know the change occurring to the topology of the single loop network, to which network switch or network switches 10 the abnormalities occur, and to which control port or control ports 102 the abnormalities occur through the abnormal switch information and the abnormal port information in the received recovery control frame RF. Thereby, the controller 26 can dynamically adjust the settings of each network switch 10 in the single loop network according to the abnormal switch information and the abnormal port information, so as to change a first route including an abnormal link to a second route not including the abnormal link. The change is made in the second layer, i.e., the data link layer. For example, the first route in the second network instance is network switch 1-2-3, and the second route in the second network instance after the change is network switch 1-4-3. Each network switch 10 stores a static forwarding database, and the controller 26 is responsible for setting entries of each of the static forwarding databases to realize the aforementioned route change.

Table 1 shows forwarding entries of the network switches 10 in FIG. 3A and FIG. 3B (i.e., the initial state). For example, in the first network instance, when the network switch 1 receives a data frame whose destination is the address of the network apparatus 27, the data frame is forwarded via the redirect port 21. When the network switch 1 receives a data frame whose destination is the address of the network apparatus 28, the data frame is forwarded via the control port 11B.

TABLE 1

| | Network switch | MAC address | Port |
|---|---|---|---|
| First | Network switch 1 | Address of network apparatus 27 | 21 |
| network | | Address of network apparatus 28 | 11B |
| instance | Network switch 4 | Address of network apparatus 27 | 14A |
| | | Address of network apparatus 28 | 14B |
| | Network switch 3 | Address of network apparatus 27 | 13A |
| | | Address of network apparatus 28 | 22 |
| Second | Network switch 1 | Address of network apparatus 27 | 21 |
| network | | Address of network apparatus 28 | 11A |
| instance | Network switch 2 | Address of network apparatus 27 | 12B |
| | | Address of network apparatus 28 | 12A |
| | Network switch 3 | Address of network apparatus 27 | 13B |
| | | Address of network apparatus 28 | 22 |

Table 2 shows forwarding entries of the network switches 10 in FIG. 6A and FIG. 6B (i.e., the alternate topology).

TABLE 2

| | Network switch | MAC address | Port |
|---|---|---|---|
| First | Network switch 1 | Address of network apparatus 27 | 21 |
| network | | Address of network apparatus 28 | 11B |
| instance | Network switch 4 | Address of network apparatus 27 | 14A |
| | | Address of network apparatus 28 | 14B |
| | Network switch 3 | Address of network apparatus 27 | 13A |
| | | Address of network apparatus 28 | 22 |
| Second | Network switch 1 | Address of network apparatus 27 | 21 |
| network | | Address of network apparatus 28 | 11B |
| instance | Network switch 4 | Address of network apparatus 27 | 14A |
| | | Address of network apparatus 28 | 14B |
| | Network switch 3 | Address of network apparatus 27 | 13A |
| | | Address of network apparatus 28 | 22 |

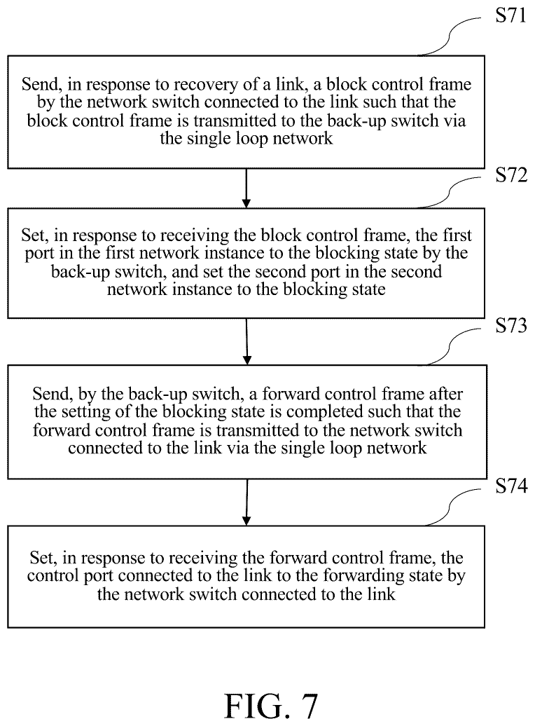

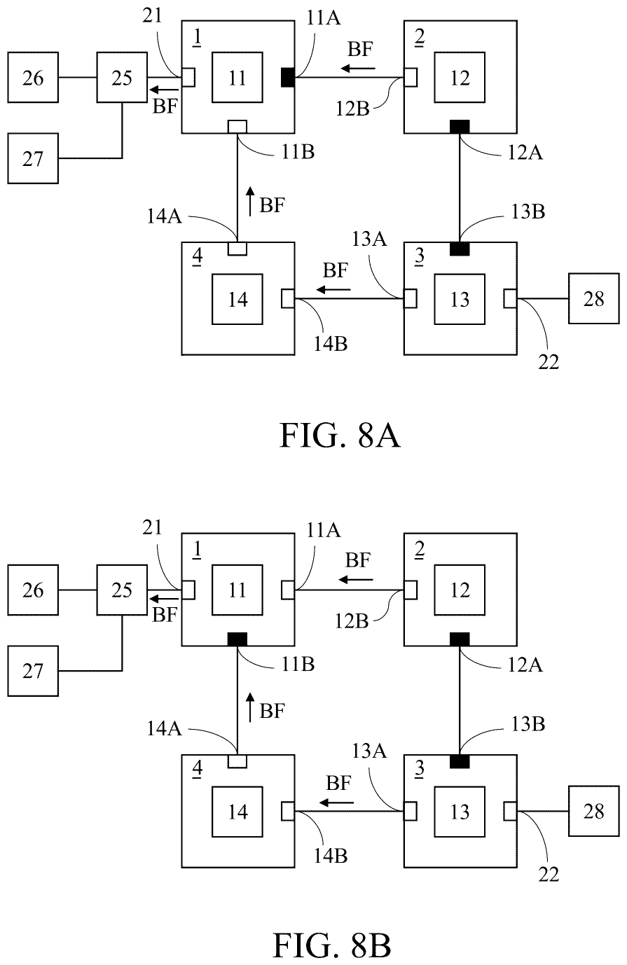

Referring to FIG. 7, FIG. 8A and FIG. 8B, FIG. 7 is a flowchart (II) of a multi-instance single loop topology adjustment method according to an embodiment of the instant disclosure, and FIG. 8A and FIG. 8B are respectively schematic diagrams showing recovery of a link in the single loop network in the first network instance and the second network instance according to an embodiment of the instant disclosure.

Step S71: In response to recovery of the link, the network switches 2 and 3 connected to the link send a block control frame BF such that the block control frame BF is transmitted to the back-up switch (the network switch 1 here) via the single loop network. Specifically, the block control frame BF is sent via another control port 12B and 13A different from the aforementioned abnormal control ports 12A and 13B.

Step S72: In response to receiving the block control frame BF, the back-up switch (the network switch 1 here) sets the first port (the control port 11A) in the first network instance to the blocking state (as shown in FIG. 8A), and sets the second port (the control port 11B) in the second network instance to the blocking state (as shown in FIG. 8B).

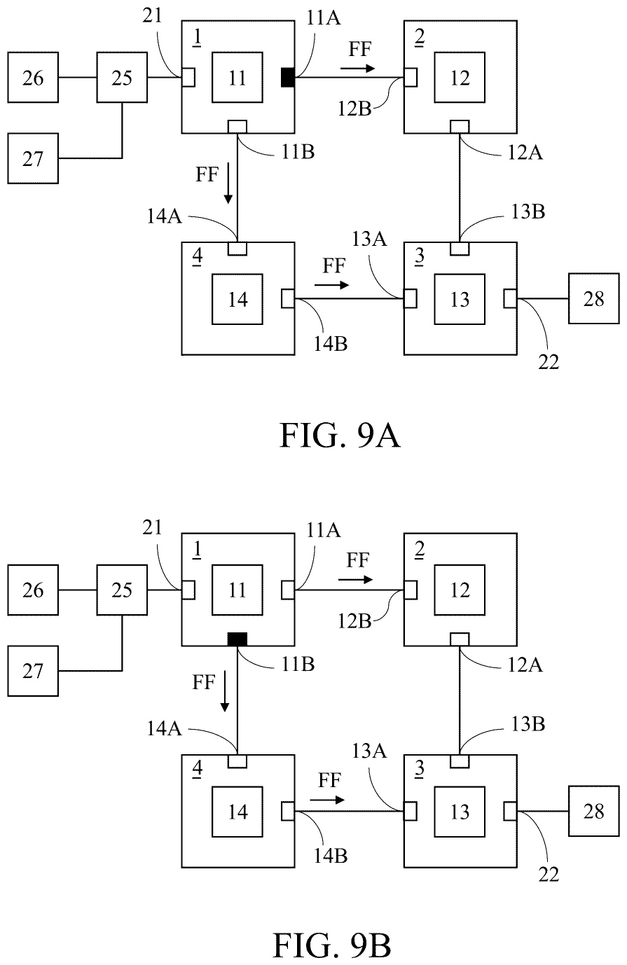

Referring to FIG. 7, FIG. 9A and FIG. 9B, FIG. 9A and FIG. 9B are respectively schematic diagrams showing recovery of a topology in the single loop network in the first network instance and the second network instance according to an embodiment of the instant disclosure.

Step S73: The back-up switch (the network switch 1 here) sends a forward control frame FF after the setting of the blocking state is completed such that the forward control frame FF is transmitted to the network switches 2 and 3 connected to the link via the single loop network. Specifically, the forward control frame FF is sent via the two control ports 11A and 11B.

Step S74: The network switches 2 and 3 connected to the link set, in response to receiving the forward control frame FF, the control ports 12A and 13B connected to the link to the forwarding state. Thereby, the network topology of the single loop network is recovered to the state before the abnormalities occur.

In some embodiments, as shown in FIG. 8A and FIG. 8B, the back-up switch further transmits the block control frame BF to the controller 26 via the redirect port 21. The block control frame BF carries a recovery switch information and a recovery port information when it is generated. Specifically, the block control frame BF sent by the network switch 2 includes: a recovery switch information corresponding to the network switch 2 and a recovery port information corresponding to the control port 12A. Similarly, the block control frame BF sent by the network switch 3 includes: a recovery switch information corresponding to the network switch 3 and a recovery port information corresponding to the control port 13B. In this way, the controller 26 can know the change occurring to the topology of the single loop network, which abnormal network switch or network switches 10 have been recovered, and which abnormal control port or control ports 102 have been recovered through the recovery switch information and the recovery port information in the received block control frame BF. Thereby, the controller 26 can dynamically adjust the settings of each network switch 10 in the single loop network according to the recovery switch information and the recovery port information, so as to change the second route not including the recovered link to the first route including the recovered link. The change is made in the second layer, i.e., the data link layer. For example, the first route in the second network instance is network switch 1-2-3, and the second route in the second network instance is network switch 1-4-3. Each network switch 10 stores a static forwarding database, and the controller 26 is responsible for setting entries of each of the static forwarding databases to realize the aforementioned route change. When the topology is recovered, the forwarding entries of the network switch 10 are shown in Table 1.

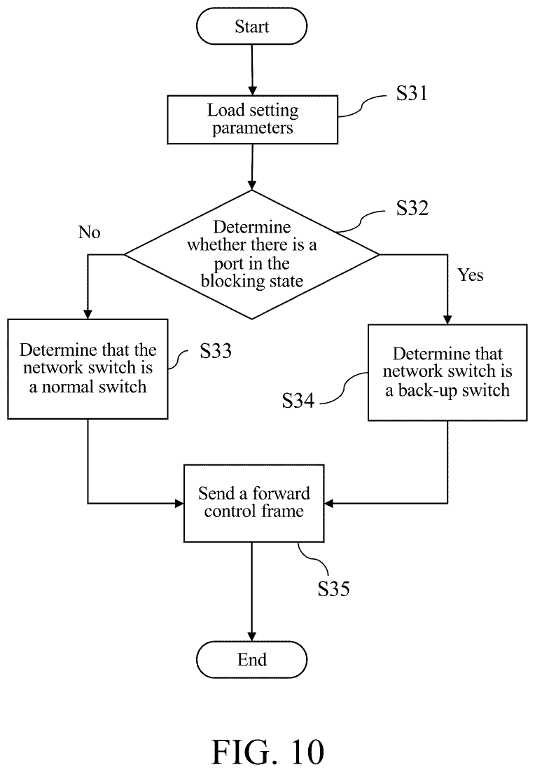

In order to facilitate the implementation of the single loop network in the embodiments above, the execution procedure of each network switch 10 constituting the single loop network will be described below. FIG. 10 is a flowchart of a network switch 10 initialization procedure according to some embodiments of the instant disclosure. First, in step S31, the processing circuit 101 loads setting parameters. The setting parameters may be stored in a parameter file and used for setting each control port 102 defaulted to the forwarding state or the blocking state. In some embodiments, the processing circuit 101 has a memory to store the parameter file. In some embodiments, the processing circuit 101 is coupled to an external memory to read the parameter file stored in the external memory. After step S31, step S32 is executed: the processing circuit 101 determines whether there is a control port 102 in the blocking state in each network instance. If not, the processing circuit 101 determines that the network switch 10 is a normal switch in the network instance, which is step S33. If so, the processing circuit 101 determines that the network switch 10 is a back-up switch in the network instance, which is step S34. After step S33 and step S34, the processing circuit 101 respectively sends a forward control frame FF via the two control ports 102, which is step S35.

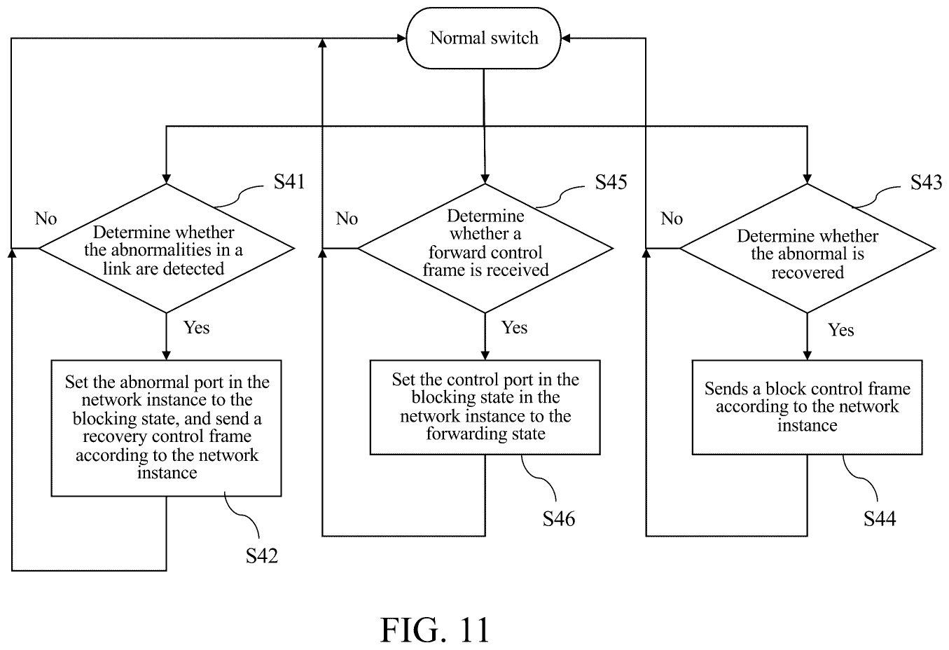

FIG. 11 is a flowchart of an execution procedure of a processing circuit 101 of a normal switch according to some embodiments of the instant disclosure. In step S41, the processing circuit 101 determines whether abnormalities of the control port 102 in the network instances are detected (that is, the abnormalities in a link are detected). In response to detecting the abnormalities of the control port 102, step S42 is executed: the processing circuit 101 sets the abnormal control port 102 in this network instance to the blocking state, and sends a recovery control frame RF via the other control port 102 according to this network instance. In step S43, the processing circuit 101 determines whether the abnormal port is recovered. After repair actions such as maintenance, the processing circuit 101 executes step S44 in response to detecting recovery of the control port 102 in the network instance, and sends a block control frame BF via the other control port 102 according to this network instance. In step S45, the processing circuit 101 determines whether a forward control frame FF is received. In response to receiving the forward control frame FF (which indicates that the back-up port of the back-up switch has been switched back to the blocking state), step S46 is executed: the processing circuit 101 sets the control port 102 in the blocking state in the network instance to the forwarding state.

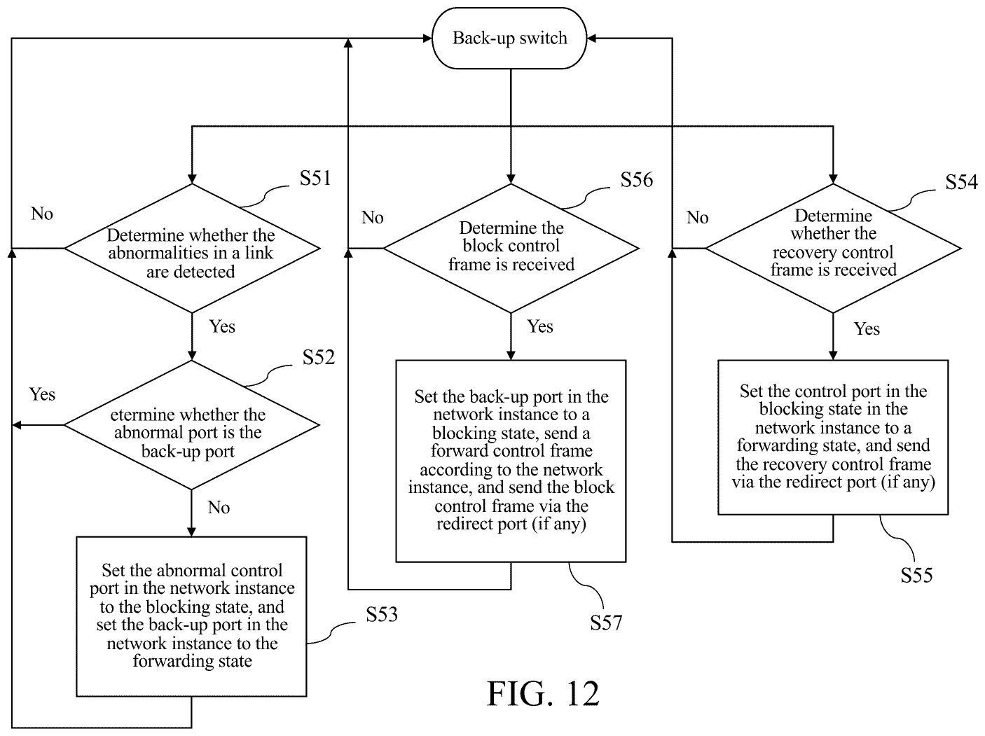

FIG. 12 is a flowchart of an execution procedure of a processing circuit 101 of a back-up switch according to some embodiments of the instant disclosure. In step S51, the processing circuit 101 determines whether abnormalities of the control port 102 in the network instances are detected (that is, the abnormalities in a link are detected). If so, step S52 is executed: it is determined whether the abnormal control port 102 in this network instance is the back-up port. If the determination result of step S52 is no, it indicates that the abnormalities occur to the other control port 102 in the forwarding state (the network topology should be further adjusted and step S53 should be executed). In step S53, the processing circuit 101 sets the abnormal control port 102 in this network instance to the blocking state, and sets the back-up port in this network instance to the forwarding state. Thereby, the single loop network is readjusted so as to resume to normal operation. If the determination result of step S52 is yes, then the abnormalities occur to the control port 102 in the blocking state. In this case, no processing is required, because the abnormal control port 102 is in the blocking state and it does not forward the frame or affect the transmission of the frame.

In step S54, the processing circuit 101 determines whether the recovery control frame RF is received in the network instance. In response to receiving the recovery control frame RF (which indicates that there are abnormalities occurring to the control ports 102 of other network switches 10), step S55 is executed: the processing circuit 101 sets the control port 102 in the blocking state (i.e., the back-up port) in this network instance to a forwarding state, and if the back-up switch has a redirect port 21, the recovery control frame RF is sent via the redirect port 21. Here, the control ports 102 originally in the blocking state are used as back-up ports. By switching the back-up ports to the forwarding state, the single loop network can be readjusted so as to resume to normal operation.

In step S56, the processing circuit 101 determines whether the block control frame BF is received in the network instance. In response to receiving the block control frame BF (which indicates the abnormal control ports 102 of other network switches 10 are recovered), step S57 is executed: the processing circuit 101 sets the back-up port in this network instance to a blocking state and sends a forward control frame FF via the control port 102, and if the back-up switch has a redirect port 21, the block control frame BF is sent via the redirect port 21.

In some embodiments, the processing circuit 101 is realized by a central processing unit (CPU), a microprocessor, an application-specific integrated circuit (ASIC), a system on a chip (SOC) or the like.

In some embodiments, the aforementioned forwarding state may be the forwarding state defined by the STP, and the aforementioned blocking state may be the blocking state defined by the STP. The control frame may be a BPDU defined by the STP. Based on this, the network switches 11 to 14 are also applicable to STP and RSTP. The aforementioned network instances are deployed in accordance with the Multiple Spanning Tree Protocol (MSTP).

According to the multi-instance single loop topology adjustment method and network switch provided in some embodiments of the instant disclosure, different back-up ports are configured for different network instances, so that virtual local area network traffic is transmitted along different paths in the network instances, and thus, the traffic can be dispersed. Moreover, for the abnormalities occurring in the link, the network instances each send control frames to adjust and recover the topology. In addition, in some embodiments, the block control frame BF and the recovery control frame RF are forwarded to the controller 26 via the redirect port 21, so that the data path can be further dynamically adjusted according to the link condition.

What is claimed is:

1. A multi-instance single loop topology adjustment method, applied to a single loop network, the single loop network comprising a plurality of network switches connected in series in a loop, each of the network switches comprising two control ports, every adjacent two of the network switches being respectively connected via the corresponding control ports, one of the network switches being a back-up switch, and the rest network switches being each a normal switch, wherein the multi-instance single loop topology adjustment method comprises:
defaulting, in a first network instance, a first port in the two control ports of the back-up switch to a blocking state;
defaulting, in a second network instance, a second port in the two control ports of the back-up switch to the blocking state;
sending, in response to abnormalities occurring in a link of the single loop network, a recovery control frame by the network switch connected to the link such that the recovery control frame is transmitted to the back-up switch via the single loop network; and
setting, in response to receiving the recovery control frame, the first port in the blocking state in the first network instance to a forwarding state by the back-up switch, and setting the second port in the blocking state in the second network instance to the forwarding state.

2. The multi-instance single loop topology adjustment method according to claim 1, wherein the back-up switch further comprises a redirect port and is connected to a controller via the redirect port, and the back-up switch further transmits the recovery control frame to the controller via the redirect port in response to receiving the recovery control frame.

3. The multi-instance single loop topology adjustment method according to claim 2, wherein the recovery control frame comprises an abnormal switch information and an abnormal port information, the abnormal switch information corresponds to the network switch connected to the abnormal link, and the abnormal port information corresponds to the control port of the network switch connected to the abnormal link.

4. The multi-instance single loop topology adjustment method according to claim 3, wherein the controller changes a first route to a second route according to the abnormal switch information and the abnormal port information, the first route comprises the abnormal link, and the second route does not comprise the abnormal link.

5. The multi-instance single loop topology adjustment method according to claim 1, wherein the recovery control frame is sent in both the first network instance and the second network instance.

6. The multi-instance single loop topology adjustment method according to claim 1, further comprising:
sending, in response to recovery of the link, a block control frame by the network switch connected to the link such that the block control frame is transmitted to the back-up switch via the single loop network; and
setting, in response to receiving the block control frame, the first port in the first network instance to the blocking state by the back-up switch, and setting the second port in the second network instance to the blocking state.

7. The multi-instance single loop topology adjustment method according to claim 6, further comprising:
sending, by the back-up switch, a forward control frame after the setting of the blocking state is completed such that the forward control frame is transmitted to the network switch connected to the link via the single loop network; and
setting, in response to receiving the forward control frame, the control port connected to the link to the forwarding state by the network switch connected to the link.

8. The multi-instance single loop topology adjustment method according to claim 6, wherein the block control frame comprises a recovery switch information and a recovery port information, the recovery switch information corresponds to the network switch connected to the recovered link, and the recovery port information corresponds to the control port of the network switch connected to the recovered link; and the back-up switch further comprises a redirect port and is connected to a controller via the redirect port, and the back-up switch further transmits the block control frame to the controller via the redirect port.

9. The multi-instance single loop topology adjustment method according to claim 8, wherein the controller changes a second route to a first route according to the recovery switch information and the recovery port information, the first route comprises the recovered link, and the second route does not comprise the recovered link.

10. The multi-instance single loop topology adjustment method according to claim 1, wherein a frame transmitted to a destination apparatus via the single loop network is transmitted along different paths in the first network instance and the second network instance respectively.

11. A network switch, comprising:
two control ports; and
a processing circuit, coupled to the two control ports and executing:
determining whether either of the two control ports in a network instance is defaulted to a blocking state, if so, determining that the network switch is a back-up switch in the network instance, and if not, determining that network switch is a normal switch in the network instance;
if determining that the network switch is the normal switch in the network instance, executing the following determination logic, comprising:
determining whether abnormalities occurring in a link connected to either of the control ports are detected, if so, setting the control port connected to the abnormal link to the blocking state, and sending a recovery control frame via the other control port according to the network instance; and
if determining that the network switch is the back-up switch in the network instance, executing the following determination logic, comprising:
determining whether the recovery control frame is received in the network instance, and if so, setting the control port in the blocking state in the network instance to a forwarding state; and
sending the recovery control frame to a controller via a redirect port.

12. The network switch according to claim 11, wherein the processing circuit further executes:
if determining that the network switch is the normal switch in the network instance, executing the following determination logic, comprising:
determining whether a forward control frame is received in the network instance, and if so, setting the control port in the blocking state in the network instance to the forwarding state; and
determining whether the link is recovered, and if so, sending a block control frame via the control port not connected to the link according to the network instance; and
if determining that the network switch is the back-up switch in the network instance, sending the forward control frame via the two control ports, and executing the following determination logic, comprising:
determining whether the block control frame is received in the network instance, and if so, setting the control port in the forwarding state in the network instance to the blocking state, sending the forward control frame via the other control port, and sending the block control frame to the controller via the redirect port.
